(19) United States
(12) Patent Application Publication
(10) Pub. No.: US 2008/0198347 A1
(43) Pub. Date: Aug. 21, 2008

(54) IMMERSION EXPOSURE APPARATUS AND METHOD OF MANUFACTURING DEVICE

(75) Inventors: Youji Kawasaki, Utsunomiya-shi (JP); Yoshio Kawanobe, Utsunomiya-shi (JP); Hitoshi Nakano, Utsunomiya-shi (JP); Mikio Arakawa, Utsunomiya-shi (JP); Takahito Chibana, Utsunomiya-shi (JP); Yoichi Matsuoka, Shioya-gun (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/028,933

(22) Filed: Feb. 11, 2008

(30) Foreign Application Priority Data
Feb. 16, 2007 (JP) 2007-036811
Oct. 15, 2007 (JP) 2007-268311

(51) Int. Cl. G03B 27/52

(52) U.S. Cl. 355/30

(57) ABSTRACT

An immersion exposure apparatus for exposing a substrate via liquid is disclosed. The apparatus comprises a projection optical system configured to project an image of a pattern of a reticle onto the substrate, a first recovery nozzle arranged at a periphery of a final optical element of the projection optical system and configured to recover liquid from a gap between the final optical element and the substrate, and a detector configured to detect a foreign particle in the liquid recovered via the first recovery nozzle.

### BACKGROUND OF THE INVENTION

1. Field of the Invention

The present invention relates to an immersion exposure apparatus for exposing a substrate via liquid, and a method of manufacturing a device.

2. Description of the Related Art

An exposure apparatus for manufacturing a device such as a semiconductor device or liquid crystal device is constantly required to improve the resolving power. To improve the resolving power of the exposure apparatus, the NA of a projection optical system is increasing and the wavelength of exposure light is shortening. The wavelength of the exposure light has shifted from the 365-nm i-line to a KrF excimer laser wavelength of 248 nm and, recently, to an ArF excimer laser wavelength of 193 nm.

An immersion exposure scheme is currently receiving a great deal of attention as a technique for further improving the resolving power (Japanese Patent Laid-Open No. 2006-140459). One of exposure apparatuses of the immersion exposure scheme (immersion exposure apparatus) is the one which exposes a substrate while the space between the substrate on a substrate stage and at least part of the final surface of a projection optical system is filled with a liquid. This exposure apparatus supplies the liquid to the space from a supply nozzle arranged at the periphery of the projection optical system, and recovers the liquid from the space via a recovery nozzle arranged at the periphery of the projection optical system.

In the exposure apparatus of the immersion exposure scheme as described above, if a bubble or a foreign particle (foreign substance) such as an impurity particle exists in the liquid, it can shield exposure light or adhere on, e.g., the substrate or the final surface of the projection optical system. A foreign particle adhering on the substrate can cause a random failure, and that adhering on the final surface of the projection optical system can cause a failure common to a plurality of shot regions or a plurality of substrates.

### SUMMARY OF THE INVENTION

The present invention has been made in consideration of the above-described problems, and has as its exemplary object to provide a novel, useful exposure apparatus which can detect a foreign particle that has an influence on exposure.

According to the present invention, there is provided an immersion exposure apparatus for exposing a substrate via liquid, the apparatus comprising a projection optical system configured to project an image of a pattern of a reticle onto the substrate, a first recovery nozzle arranged at a periphery of a final optical element of the projection optical system and configured to recover liquid from a gap between the final optical element and the substrate, and a detector configured to detect a foreign particle in the liquid recovered via the first recovery nozzle.

Further features and aspects of the present invention will become apparent from the following description of exemplary embodiments with reference to the attached drawings.

### BRIEF DESCRIPTION OF THE DRAWINGS

FIG. 1 is a view exemplifying the schematic arrangement of an exposure apparatus according to a preferred embodiment of the present invention;

FIG. 2 is a view exemplifying the schematic arrangement of an exposure apparatus according to another preferred embodiment of the present invention;

FIG. 3 is a flowchart illustrating the overall sequence of a process of manufacturing a semiconductor device; and

FIG. 4 is a flowchart illustrating details of the wafer process.

FIG. 5 is a view showing the schematic arrangement of an exposure apparatus according to the preferred third embodiment of the present invention;

FIG. 6 is a view showing the schematic arrangement of an exposure apparatus according to the preferred fourth embodiment of the present invention;

FIG. 7 is a graph illustrating the relationship between the integrated value (integrated liquid supply amount) of the amount of liquid supplied to a space via a supply nozzle (or supply line) and the integrated value (integrated foreign particle amount) of the amount of foreign particles detected by a foreign particle detection unit;

FIG. 8 is a flowchart illustrating a control sequence by a control unit, which is based on the output (i.e., the detection result) from the foreign particle detection unit;

FIG. 9 is a graph illustrating the relationship between the integrated value (integrated liquid supply amount) of the amount of liquid supplied to a space via a supply nozzle (or supply line) and the integrated value (integrated foreign particle amount) of the amount of foreign particles detected by a foreign particle detection unit; and

FIG. 10 is a flowchart illustrating a control sequence by a control unit, which is based on the output (i.e., the detection result) from the foreign particle detection unit.

### DESCRIPTION OF THE EMBODIMENTS

Preferred embodiments of the present invention will be described below with reference to the accompanying drawings.

### First Embodiment

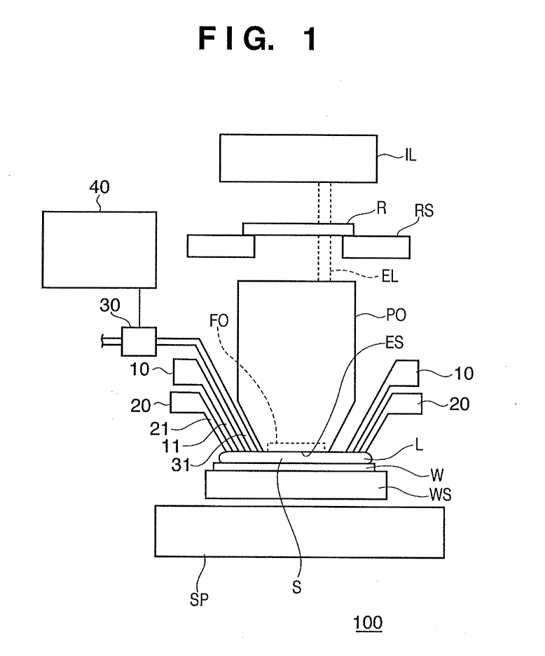

FIG. 1 is a view exemplifying the schematic arrangement of an exposure apparatus according to a preferred embodiment of the present invention. An exposure apparatus 100 shown in FIG. 1 comprises a reticle stage RS which holds a reticle R, an illumination optical system IL which illuminates the reticle R, a substrate stage WS which holds a substrate (wafer) W, and a projection optical system PO which projects an image of a pattern of the reticle R onto the substrate W. The exposure apparatus 100 can be, e.g., an exposure apparatus which scan-exposes the substrate W with exposure light EL shaped by a slit, while scan-driving the reticle R and substrate W, or an exposure apparatus which exposes the substrate W with the exposure light EL while the reticle R and substrate W are at rest. The substrate stage WS has a substrate chuck (not shown) which holds the substrate W, and holds and moves the substrate W via the substrate chuck. The substrate stage WS can be driven on a stage platen SP in, e.g., six axial directions.

The exposure apparatus 100 exposes the substrate W while a space (gap) S between the substrate W on the substrate stage WS and at least part of a final surface ES of the projection optical system PO is filled with a liquid L. The at least part of the final surface ES of the projection optical system PO includes the optical path of the exposure light EL. The final surface ES of the projection optical system PO means a surface facing the substrate stage WS or substrate W, of the two surfaces of an optical element (final optical element) FO that is nearest to the substrate stage WS or substrate W of a plurality of optical members of the projection optical system P0.

To control the liquid, the exposure apparatus 100 also comprises a supply unit 10 which supplies the liquid L to the space S via a supply nozzle 11, and a recovery unit 20 which recovers the liquid L from the space S via a recovery nozzle (second recovery nozzle) 21. The supply nozzle 11 is arranged at the periphery of the projection optical system P0. The supply nozzle 11 may discharge the liquid toward the space S, or the liquid discharged from the supply nozzle 11 may be allowed to migrate so as to fill the space S. The recovery nozzle 21 is arranged at the periphery of the projection optical system P0.

The supply nozzle 11 is typically closer to the projection optical system P0 than the recovery nozzle 21. According to one embodiment, each of the supply nozzle 11 and recovery nozzle 21 can have a ring shape. According to another embodiment, each of the supply nozzle 11 and recovery nozzle 21 can have a linear shape.

The supply unit 10 can include, e.g., a valve, pump, and supply tank to control the liquid to be discharged via the supply nozzle 11, in addition to the supply nozzle 11. The recovery unit 20 can include, e.g., a valve, pump, and recovery tank to control the liquid to be recovered via the recovery nozzle 21, in addition to the recovery nozzle 21.

To detect a foreign particle, the exposure apparatus 100 also comprises a recovery nozzle (first recovery nozzle) 31 and foreign particle detection unit (detector) 30. The recovery nozzle 31 extends toward the substrate stage WS. For example, the recovery nozzle 31 can be interposed between the projection optical system PO and the recovery nozzle 21. The recovery nozzle 31 can be arranged such that it maintains a predetermined positional relationship with the projection optical system PO. The recovery nozzle 31 is not arranged on the substrate stage WS but extends toward it so that the foreign particle detection unit (detector) 30 can detect a foreign particle such as an impurity in the liquid L parallel to the exposure of the substrate W with the exposure light EL. This makes it possible to suppress a decrease in throughput because there is no need to switch between substrate exposure processing and foreign particle detection processing. It is also possible to more accurately detect a foreign particle that has an influence on exposure because the liquid can be recovered or sampled from the exposure shot region or its vicinity. It is therefore possible to downsize the substrate stage as compared with the case in which the foreign particle detection unit is mounted on the substrate stage.

The foreign particle detection unit 30 detects a foreign particle in the liquid recovered or sampled from the space S via the recovery nozzle 31. For example, the foreign particle detection unit 30 irradiates the liquid with light and detects a foreign particle on the basis of the intensity of the scattered light from the liquid. The inspection result obtained by the foreign particle detection unit 30 is sent to a control unit 40.

The exposure apparatus 100 also comprises the control unit 40 which executes error processing on the basis of the output (i.e., the detection result) from the foreign particle detection unit 30. The error processing includes, e.g., at least one of warning issuing processing and processing for stopping the exposure of the substrate.

### Second Embodiment

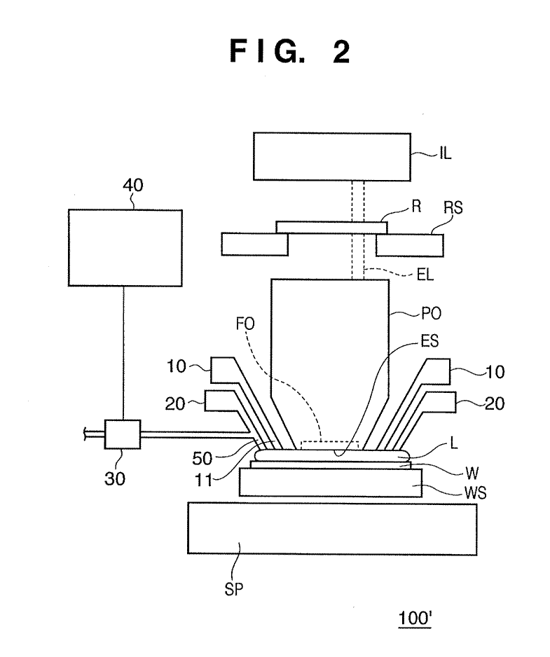

FIG. 2 is a view exemplifying the schematic arrangement of an exposure apparatus according to another preferred embodiment of the present invention. The same reference numerals as in the exposure apparatus 100 shown in FIG. 1 denote the same constituent components in FIG. 2. In an exposure apparatus 100′ shown in FIG. 2, a recovery nozzle 50 serves both as the above-described recovery nozzles 21 and 31.

### Third Embodiment

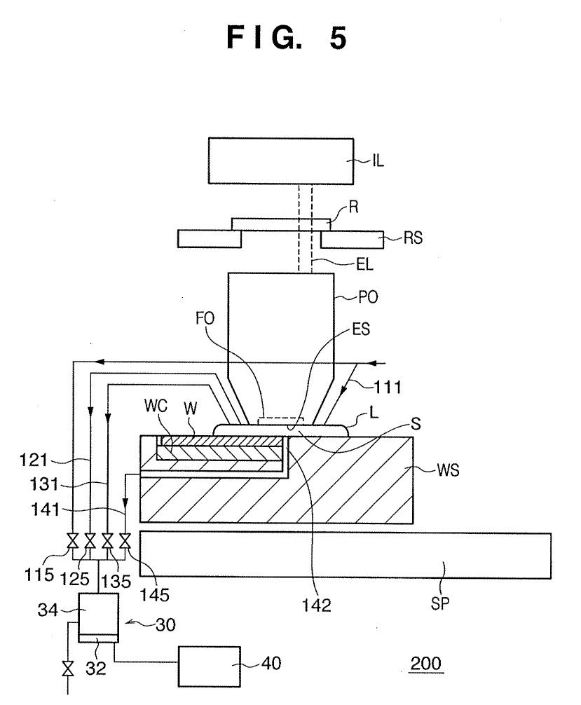

FIG. 5 is a view showing the schematic arrangement of an exposure apparatus according to the preferred third embodiment of the present invention. The same reference numerals as in the exposure apparatus 100 shown in FIG. 1 denote the same constituent components in an exposure apparatus 200 shown in FIG. 5.

A substrate W is held by a substrate chuck WC arranged on a substrate stage WS. The substrate stage WS is preferably configured such that a top plate (a liquid supporting plate) having a surface flush with the surface of the substrate W is arranged at the periphery of the substrate W. This arrangement is advantageous to driving the substrate stage WS such that the peripheral region of the substrate W is positioned below a projection optical system PO and exposing an edge shot region of the substrate S.

To control a liquid, the exposure apparatus 200 comprises a supply line 111 which supplies a liquid L to a space S, and a recovery line 121 which recovers the liquid L from the space S. Although not shown in FIG. 5, the above-described supply nozzle 11 can connect to the distal end of the supply line 111, while the above-described recovery nozzle 21 can connect to the distal end of the recovery line 121.

To detect a foreign particle, the exposure apparatus 200 comprises recovery lines 131 and 141. Although not shown in FIG. 5, the above-described recovery nozzle (first recovery nozzle) 31 can connect to the distal end of the recovery line 131. The recovery line 141 connects to a recovery nozzle 142 inserted in an opening of the upper surface of the substrate stage WS.

The supply line 111 and recovery lines 121, 131, and 141 connect to a foreign particle detection unit (detector) 30 via valves 115, 125, 135, and 145.

The foreign particle detection unit 30 can include, e.g., a container 34 which temporarily stores the liquid, and a QCM sensor 32 arranged such that the surfaces of electrodes of a quartz oscillator are exposed inside the container 34. The foreign particle detection unit 30 detects a foreign particle on the basis of the resonance frequency of the quartz oscillator, which fluctuates depending on the presence/absence of a foreign particle adhering on the surface of the electrode of the quartz oscillator.

A control unit 40 controls the opening/closing of the valves 115, 125, 135, and 145 so as to selectively connect a part (e.g., one) of the supply line 111 and recovery lines 121, 131, and 141 to the foreign particle detection unit 30. For example, when the control unit 40 opens the valve 115, the foreign particle detection unit 30 detects a foreign particle in the liquid flowing through the supply line 111.

### Fourth Embodiment

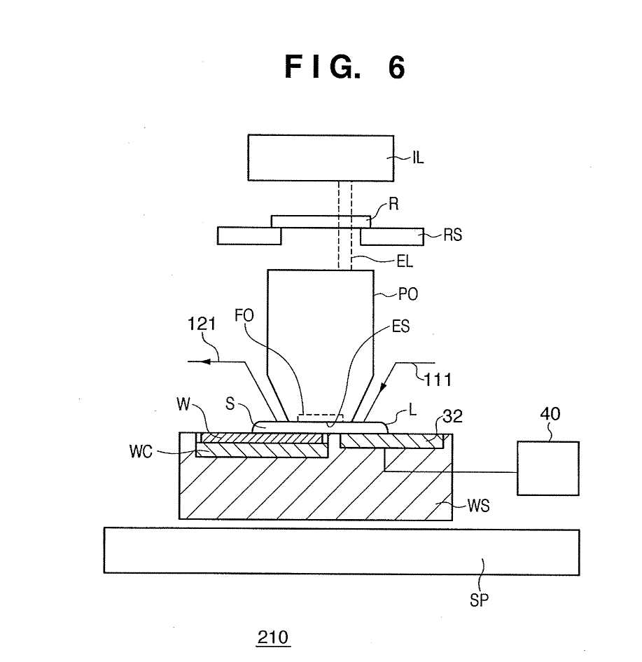

FIG. 6 is a view showing the schematic arrangement of an exposure apparatus according to the preferred fourth embodiment of the present invention. The same reference numerals as in the exposure apparatuses 100 and 200 shown in FIGS. 1 and 5 denote the same constituent components in an exposure apparatus 210 shown in FIG. 6.

In the exposure apparatus 210 according to this embodiment, a foreign particle detection unit (detector) including a QCM sensor 32 is arranged on a substrate stage WS. To detect a foreign particle in a liquid L, the substrate stage WS is driven such that the liquid L is positioned on the QCM sensor 32, i.e., the QCM sensor 32 is positioned below a projection optical system P0. The foreign particle detection unit (detector) detects a foreign particle in the liquid on the substrate stage WS.

### Fifth Embodiment

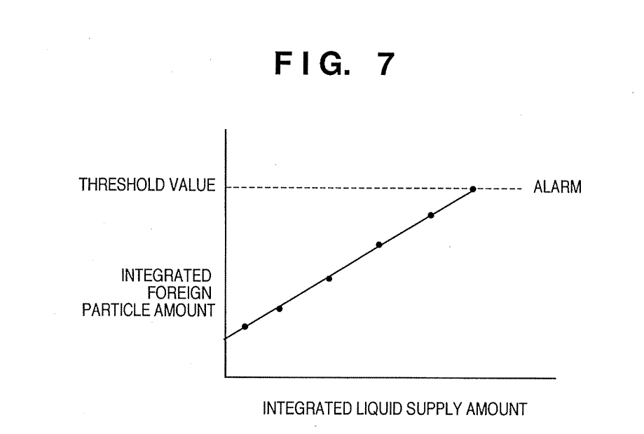

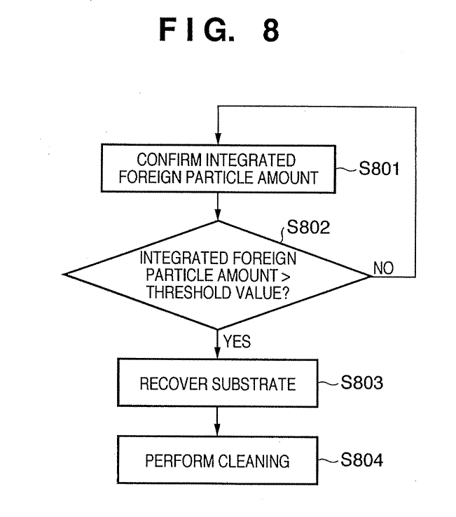

This embodiment exemplifies error processing executed on the basis of the output (i.e., the detection result) from a foreign particle detection unit 30. FIG. 7 is a graph illustrating the relationship between the integrated value (integrated liquid supply amount) of the amount of liquid supplied to a space S via a supply nozzle 11 (or supply line 111) and the integrated value (integrated foreign particle amount) of the amount of foreign particles detected by the foreign particle detection unit 30. FIG. 8 is a flowchart illustrating a control sequence by a control unit 40, which is based on the output (i.e., the detection result) from the foreign particle detection unit 30.

In step S801, the control unit 40 confirms the integrated foreign particle amount obtained by integrating the amount of foreign particles detected by the foreign particle detection unit 30. The integrated foreign particle amount may be sent from the foreign particle detection unit 30 to the control unit 40, or may be obtained by sending the detected foreign particle amount from the foreign particle detection unit 30 to the control unit 40 at an appropriate timing and integrating it by the control unit 40.

In step S802, the control unit 40 determines whether the integrated foreign particle amount has exceeded a preset threshold value. If the control unit 40 determines that the integrated foreign particle amount has exceeded the threshold value, the process advances to step S803; otherwise, the process returns to step S801.

In step S803, the control unit 40 recovers a substrate W on a substrate chuck WC using a transport mechanism (not shown). If the substrate W is not held by the substrate chuck WC, the process in step S803 is skipped.

In step S804, a constituent component or part which has an influence on the quality (foreign particle amount) of a liquid L in the space S is cleaned under the control of the control unit 40. The constituent component or part can include, e.g., a supply unit 10 (including the supply nozzle 11 and supply line 111), a recovery unit 20 (including a recovery nozzle 21 and recovery line 121), the surface of a substrate stage WS, and the lower portion of a projection optical system PO. This cleaning can be done by, e.g., supplying a cleaning liquid from the supply unit 10 to the space S. The operator may manually perform this cleaning operation.

### Sixth Embodiment

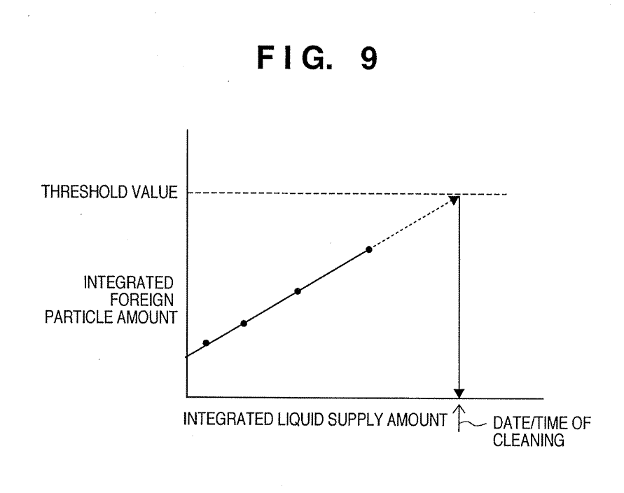

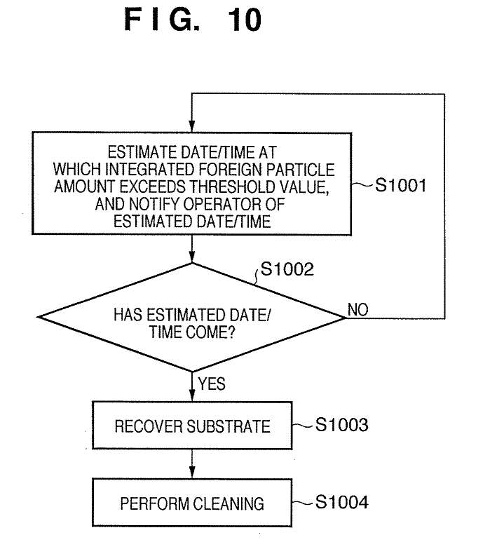

This embodiment exemplifies another error processing executed on the basis of the output (i.e., the detection result) from a foreign particle detection unit 30. FIG. 9 is a graph illustrating the relationship between the integrated value (integrated liquid supply amount) of the amount of liquid supplied to a space S via a supply nozzle 11 (or supply line 111) and the integrated value (integrated foreign particle amount) of the amount of foreign particles detected by the foreign particle detection unit 30. FIG. 10 is a flowchart illustrating a control sequence by a control unit 40, which is based on the output (i.e., the detection result) from the foreign particle detection unit 30.

In step S1001, the control unit 40 estimates a date/time (period) at which the integrated foreign particle amount exceeds a preset threshold value, on the basis of the curve of the integrated foreign particle amount illustrated in FIG. 9. The control unit 40 notifies the operator that cleaning needs to be performed at the estimated date/time (period). This estimation can be typically done by an extrapolation method.

In step S1002, the control unit 40 determines whether the date/time (period) estimated in step S1001 has come. If the estimated date/time (period) has come, the process advances to step S1003; otherwise, the process returns to step S1001. Every time the process in step S1001 is executed, the accuracy of estimating a date/time (period) at which the integrated foreign particle amount exceeds the preset threshold value increases.

In step S1003, the control unit 40 recovers a substrate W on a substrate chuck WC using a transport mechanism (not shown). If the substrate W is not held by the substrate chuck WC, the process in step S1003 is skipped.

In step S1004, a constituent component or part which has an influence on the quality (foreign particle amount) of a liquid L in the space S is cleaned under the control of the control unit 40. The constituent component or part can include, e.g., a supply unit 10 (including the supply nozzle 11 and supply line 111), a recovery unit 20 (including a recovery nozzle 21 and recovery line 121), the surface of a substrate stage WS, and the lower portion of a projection optical system PO. This cleaning can be done by, e.g., supplying a cleaning liquid from the supply unit 10 to the space S. The operator may manually perform this cleaning operation.

### Device Manufacturing Method

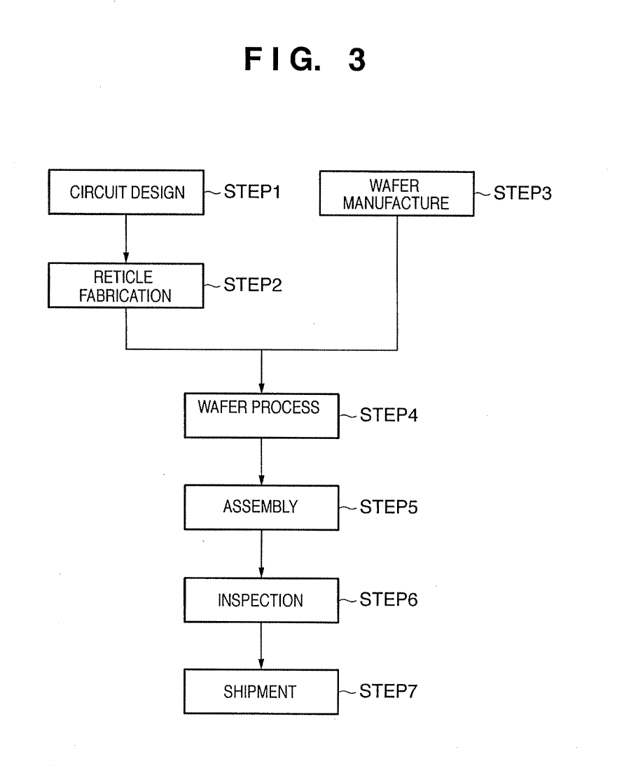

A method of manufacturing a device using the above-described exposure apparatus will be explained next. FIG. 3 is a flowchart illustrating the overall sequence of a process of manufacturing a semiconductor device. In step 1 (circuit design), the circuit of a semiconductor device is designed. In step 2 (reticle fabrication), a reticle (also called an original or mask) is fabricated on the basis of the designed circuit pattern. In step 3 (wafer manufacture), a wafer (also called a substrate) is manufactured using a material such as silicon. In step 4 (wafer process) called a preprocess, an actual circuit is formed on the wafer by lithography using the reticle and wafer. In step 5 (assembly) called a post-process, a semiconductor chip is formed using the wafer manufactured in step 4. This step includes processes such as assembly (dicing and bonding) and packaging (chip encapsulation). In step 6 (inspection), inspections including operation check test and durability test of the semiconductor device manufactured in step 5 are performed. A semiconductor device is completed with these processes and shipped in step 7.

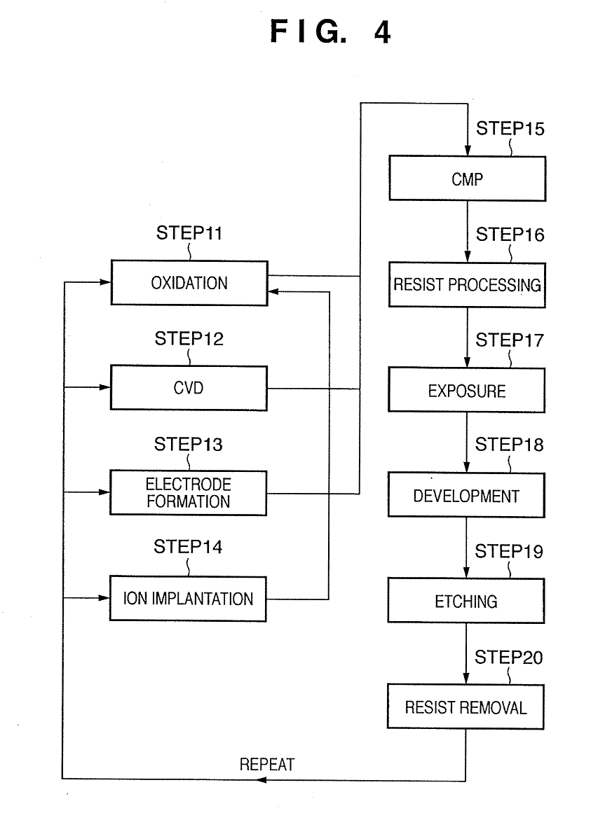

FIG. 4 is a flowchart illustrating details of the wafer process. In step 11 (oxidation), the wafer surface is oxidized. In step 12 (CVD), an insulating film is formed on the wafer surface. In step 13 (electrode formation), an electrode is formed on the wafer by vapor deposition. In step 14 (ion implantation), ions are implanted into the wafer. In step 15 (CMP), the insulating film is planarized by CMP. In step 16 (resist processing), a photosensitive agent is applied on the wafer. In step 17 (exposure), the above-described exposure apparatus is used to form a latent image pattern on the resist by exposing the wafer coated with the photosensitive agent via the mask on which the circuit pattern is formed. In step 18 (development), the latent image pattern formed on the resist on the wafer is developed to form a resist pattern. In step 19 (etching), the layer or substrate under the resist pattern is etched through an opening of the resist pattern. In step 20 (resist removal), any unnecessary resist remaining after etching is removed. By repeating these steps, a multilayered structure of circuit patterns is formed on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2007-036811 filed Feb. 16, 2007 and No. 2007-268311 filed Oct. 15, 2007, which are hereby incorporated by reference herein in their entirety.

What is claimed is:

1. An immersion exposure apparatus for exposing a substrate via liquid, said apparatus comprising:
a projection optical system configured to project an image of a pattern of a reticle onto the substrate;
a first recovery nozzle arranged at a periphery of a final optical element of said projection optical system and configured to recover liquid from a gap between the final optical element and the substrate; and
a detector configured to detect a foreign particle in the liquid recovered via said first recovery nozzle.

2. The apparatus according to claim 1, wherein said detector is used to inspect the foreign particle in the liquid recovered via said first recovery nozzle at least while exposing the substrate.

3. The apparatus according to claim 1, further comprising a supply nozzle arranged at the periphery of the final optical element and configured to supply the liquid to the gap.

4. The apparatus according to claim 3, further comprising a second recovery nozzle arranged at the periphery of the final optical element and configured to recover the liquid from the gap,
wherein said first recovery nozzle is interposed between the final optical element and said second recovery nozzle.

5. The apparatus according to claim 1, further comprising a control unit configured to execute error processing based on the output from said detector.

6. The apparatus according to claim 5, wherein said control unit is further configured to execute at least one of warning issuing processing and processing for stopping the exposure of the substrate as the error processing.

7. The apparatus according to claim 1, wherein said detector is further configured to irradiate the liquid with light and to detect a foreign particle based on the scattered light from the liquid.

8. An immersion exposure apparatus for exposing a substrate via liquid, said apparatus comprising:
a projection optical system configured to project an image of a pattern of a reticle onto the substrate;
a supply line arranged at a periphery of a final optical element of said projection optical system and configured to supply liquid to a gap between the final optical element and the substrate; and
a detector configured to detect a foreign particle in the liquid flowing trough said supply line.

9. An immersion exposure apparatus comprising:
a stage configured to hold a substrate and to move the substrate;
a projection optical system, wherein an image of a pattern of a reticle is projected onto the substrate via said projection optical system and liquid supplied to a gap between a final optical element of said projection optical system and the substrate; and
a detector configured to detect a foreign particle in the liquid at a position on said stage.

10. A method of manufacturing a device, said method comprising steps of:
exposing a substrate using an immersion exposure apparatus as defined in claim 1;
developing the exposed substrate; and
processing the developed substrate to manufacture the device.

11. A method of manufacturing a device, said method comprising steps of:
exposing a substrate using an immersion exposure apparatus as defined in claim 8;
developing the exposed substrate; and
processing the developed substrate to manufacture the device.

12. A method of manufacturing a device, said method comprising steps of:
exposing a substrate using an immersion exposure apparatus as defined in claim 9;
developing the exposed substrate; and
processing the developed substrate to manufacture the device.
